(19) United States
(12) Patent Application Publication
(10) Pub. No.: US 2016/0305673 A1
(43) Pub. Date: Oct. 20, 2016

(54) METHOD AND DEVICE FOR THE CONCURRENT TRANSFER OF HEAT AND MOISTURE BETWEEN AT LEAST TWO DIFFERENT GS STREAMS

(71) Applicant: Bernd ZEIDLER, Gladbeck (DE)

(72) Inventor: Bernd ZEIDLER, Gladbeck (DE)

(21) Appl. No.: 14/910,980

(22) PCT Filed: Jan. 13, 2015
(86) PCT No.: PCT/EP2015/050493

§ 371 Date: Feb. 8, 2016

(30) Foreign Application Priority Data
Jan. 13, 2014 (DE) 10 2014 000 135.0

(51) Int. Cl. F24F 3/147; F24F 12/00; F28D 21/00

(52) U.S. Cl. CPC F24F 3/147; F28D 21/0015; F24F 12/006; Y02B 30/563

(57) ABSTRACT

The invention relates to a method for the concurrent transfer of heat and moisture between at least two different gas streams (1, 2). The two gas streams (1, 2) communicate with each other via at least one textile exchange surface (8). The moisture present in the one gas stream (2) is transferred to the other gas stream (1) following the moisture gradient. For this purpose, the textile exchange surface (8) has a flat support which is coated with a water-binding filler.

The invention relates to a method and an apparatus for simultaneously exchanging heat and moisture between at least two different gas streams that interact with each other through at least one textile exchange membrane.

The two gas streams are usually different in that they have different temperatures and/or a different moisture contents. For example, the prototypical prior art according to DE 10 2009 000 617 relates to an apparatus for dehumidifying, heating and/or cooling a fluid, which is equipped with a textile web as an exchange membrane, along one face of which a liquid flows. In addition, gas flows over the opposite face of the textile web. Upstream of the exchange membrane, a distributor is provided for the liquid. The exchange membrane is acted upon using the liquid.

In this way, in particular in an apparatus designed as an absorber, one seeks to dehumidify a gas by means of a moisture-absorbing liquid.

The actual dehumidifying the air takes place based on a hygroscopic aqueous salt solution that is brought into contact with the supplied air. In this context, the absorber provides the largest possible specific exchange membrane in order to ensure an efficient mass and heat exchange between the air and the aqueous salt solution. The known procedure may have proven itself for dehumidifying air, however it requires the provision and use of an aqueous salt solution.

Further, DE 197 52 709 describes an exhaust-gas converter that is intended to reduce exhaust gas losses in conventional furnaces. Here, the overall objective is to produce lukewarm, dry chimney exhaust from hot, humid boiler exhaust by heat recovery, in particular in order to prevent condensation in the chimney. In addition, after the greatest possible extraction of its heat by heat exchange with circulating air or fresh air, the original combustion exhaust gas or boiler exhaust gas is still further cooled in an air condensation cooler and thereby dehumidified. Subsequently, a part of this preheated air is mixed as makeup air into the so-called chimney exhaust, so that as a result water condensation inside the chimney is prevented. However, the constructive effort associated therewith, for instance through the additional condensation cooler, is large, so that in practice such systems have not yet been implemented.

The object of the invention is to further develop such a method for simultaneously exchanging heat and moisture between at least two different gas streams and an additional apparatus such that the most efficient possible heat and moisture exchange can be achieved with a simultaneously constructively and procedurally simple design.

To attain this object, a prototypical method for simultaneous exchange of heat and moisture between at least two different gas streams is characterized within the context of the invention in that, in addition to the heat exchange that is essentially consistent and dependent on the temperature differential between the two different gas streams, an additional moisture exchange also takes place in that moisture in one gas stream is exchanged depending on moisture content or concentration level of the moisture to the other gas stream, and in addition the textile exchange membrane has a sheet-like support that is coated with a water-binding filler.

Thus, within the context reference is expressly made to a concurrent heat and moisture exchange between the two different gas streams. In principle, the gas streams may originate from or be supplied to any technical apparatus. As a rule, it is crucial that the two gas streams have a different temperature as well as a different moisture content. Thus, the previously mentioned temperature differential and different moisture contents exist between the two gas streams. Both differences provide the desired exchange of heat and moisture. In addition, the invention also assumes that the inherent moisture content of one of the gas streams, i.e. the moisture content already present in the gas stream in question, can advantageously be used to humidify the other (usually dry) gas stream. This means that, within the context of the invention, there is no additional supply of moisture or removal of moisture, but rather only moisture exchange between the two gas streams, namely depending on moisture content.

For this reason, the textile exchange membrane between the two gas streams is designed as a sheet-like support that is coated with a water-binding filler. The water-binding filler absorbs the humidity of one of the gas streams and releases it to the other gas stream according to the moisture content through the permeable textile exchange membrane. In principle, the rate of diffusion of the moisture through such a membrane can be controlled by the type of water-binding filler.

It has proven useful in this context if the sheet-like support is formed as a textile fabric made of felt and/or nonwoven fabric and/or fabric and/or knit fabric. As a general rule, the coating of the sheet-like support with the water-binding filler occurs here such that the filler is applied to the support as a suspension and in particular as a water suspension. It has proven particularly useful when the sheet-like support is passed through an immersion bath that coats it with the filler. The immersion bath is thus the water suspension in question, i.e. the suspension of water and the finely distributed filler particles therein, which in this way coats the textile fabric as desired.

The filler itself is generally composed of a hygroscopic filler material and a binder. Using the hygroscopic filler material, the moisture in one of the gas streams is bound and can be correspondingly delivered to the other, contrastingly dry, gas stream. In this context, the binder also ensures that the filler material adheres to the sheet-like support and simultaneously opens the possibility to create this sheet-like support, formed in this manner and coated with the water-binding filler, in practically any imaginable form—including three-dimensional forms.

For this purpose, typical adhesive media based on plastics such as acrylates or other plastic adhesive media may be used as a binder. In conjunction with the filler materials used, this binder ensures as a whole that the support coated with the filler can be created in principle in any shape. Even a three-dimensional shaping of the sheet-like support coated with the filler is conceivable. Here, recourse to plastic adhesive media such as acrylates opens the further option at this point to use known plastic deformation processes, such as deep drawing.

There are a plurality of choices for the hygroscopic filler materials. Thus, inorganic minerals such as aluminum silicates or tectosilicates may be used. In this context, the invention suggests, for example, the use of pumice, bentonite, zeolite, etc. Alternatively or additionally, however, inorganic salts such as lithium chloride, sodium carbonate, etc., may also be used as hygroscopic filler materials. Additionally or alternatively, the invention also recommends the use of organic absorbers or comparable hygroscopic materials, for example the use of so-called superabsorbents, that is, plastics that swell in the absorption of liquids and form a hydrogel. At this point, primarily copolymers of acrylic acid and sodium acrylate, for example polyaniline, are used.

In any case, the used hygroscopic filler and the water-storing and water-releasing filler material in connection with the binder are able to absorb the excess moisture of one of the gas streams and release it to the other relatively dry gas stream. This is ensured by the textile exchange membrane that is porous as a whole and through which the two different gas streams interact with one another.

So that the filler in connection with the binder can be properly applied for coating as a water suspension to the sheet-like support, the filler is typically in granular or powder form and is then mixed with water to form the above-described suspension or water suspension. Here, granules with a diameter of a maximum of approximately 500 μm or a corresponding powder with a powder fineness of 100 μm or less have proven to be particularly favorable. Furthermore, additional additives may also be added to a filler designed in this way, the additives likewise being added in granular or powdered form in the previously specified grain size. The additives in question may be surfactants for a reduction in the membrane tension of the water and thus an improvement in the wetting of the support, pigments, for example for coloring, or also antibacterial additives. In the case of antibacterial additives, biocides or silver compounds have proven particularly advantageous, which can effectively prevent possible bacterial growth on the textile exchange membrane in question.

The sheet-like support coated with the filler typically has a basis weight between 10 g/m² and 40 g/m². Preferable is a basis weight between approximately 50 g/m² to 150 g/m² and particular preferably of approximately 50 g/m² to 90 g/m². In this manner, the sheet-like support coated with the filler and such a membrane can, for example, be easily installed in or added to a heat exchanger. In fact, it has proven useful if the gas stream is designed on the one side as an exhaust-gas stream, for example from a heater and in particular a domestic heater, and on the other side as a supply stream for heating. The heat source and in particular domestic heat source is preferably a so-called boiler or heating system that is used, for example, for floor heating in residential units. Such a boiler is typically powered by fuel oil or natural gas. Often, such boilers are also provided as combination boilers that principally supply hot water in a continuous flow mode and can also work as part of a heat system.

In any case, such boilers are typically characterized by the fact that the exhaust-gas stream generated thereby has a relatively high moisture content that corresponds, inter alia, to a water vapor dew point in the flue gas during combustion of natural gas is only approximately 60° C. This can basically be attributed to the fact that during the combustion of methane primarily found in natural gas, a large amount of water vapor is produced by the oxidation of the hydrogen atoms of the methane. This high moisture content of nearly 100% relative humidity often results in the sooting of chimneys and fireplaces already described in the context of the prior art according to DE 197 52 709. In practice, attempts are made to counteract this by the additional installation of a chimney liner, for example made from polypropylene or stainless steel.

According to the inventions, the wet exhaust-gas stream of such a heat source and of most domestic heat sources and in particular of a boiler is used to humidify the incoming air for space heating. The supply air is usually dry, and in any case does not have the relative humidity of approximately 40% to 60% which is necessary for general human well-being. To humidify this dry-air supply, the inventive method with the special membrane is used that ensures that the moist exhaust-gas stream from the boiler is dehumidified and the dry-air supply is simultaneously humidified.

In this way, the moisture inherently present in the exhaust-gas stream, primarily caused by the combustion or natural gas or methane, is advantageously used for humidifying the supply air. Of course, this can be used both in industrial processes, as well as for air conditioning in living spaces.

In addition, the invention utilizes the fact that water present in the exhaust-gas stream of the boiler is salt-free water that is close to distilled water. This can be attributed to the fact that the water originates from the above-described oxidation process of the natural gas or methane and as a result of the process contains no or virtually no salts. This means, for example, that complex treatment measures for the desalination of water when humidifying supply air can be expressly omitted. Thus, the otherwise obligatory demineralization of the tap water normally used for humidifying is saved.

In addition, moisture and heat exchange takes place between the two gas streams, namely with concurrent complete separation of the two gas streams, i.e. of the supply air from the exhaust air. This complete separation can be attributed to the fact that the inventive support that has been coated with the water-binding filler is not or can be made not permeable to the gas fraction of the exhaust gas. Only the described condensate moisture found in the exhaust-gas stream is in a position to diffuse through such a membrane, i.e. the textile exchange membrane.

Overall, a significant increase in efficiency is observed, as well as a significant reduction in production costs. The use of materials can also be reduced, as in general the additional introduction of a liner in the chimney as is the case in the prior art can be omitted. With the use of additional fans, for example a supply fan and/or exhaust-air or exhaust-gas fan, the flow rates of the individual gas streams can be increased as needed and the efficiency improved.

The use of the correspondingly designed textile exchange membrane, i.e. the sheet-like support with the coated water-binding filler, gives increased long-term stability, as in the described case, the boiler or gas boiler temperatures for the two gas streams is observed to be no higher than approximately 130° C., which can be handled without problems by the corresponding materials. This is particularly true in the case that the sheet-like support is produced, for example, from polyester filaments. In such case, the textile exchange membrane typically ensures that the moist gas stream or exhaust-gas stream is below the dew point at the textile exchange membrane. This can be explained by the concurrent heat exchange.

In this way, the condensate is precipitated in the gas stream or exhaust-gas stream onto the textile exchange membrane and is absorbed by the water-binding filler. Because the membrane made in this way is permeable as a whole, the precipitated moisture diffuses through the textile exchange membrane to the opposite side and there comes into contact with the contrastingly dry other gas stream, i.e. the supply air in the example.

The sheet-like support can be have one or more coats of the water-binding filler. The coating thickness can thus be varied. In this way, according to the invention the possibility exists of varying the porosity of such a membrane. The moisture transmission rates for the membrane in question can thereby be set, just as, optionally, gas transmission rates. Substantial advantages may be seen herein.

The invention is hereinafter described in greater detail with reference to drawings showing a single embodiment.

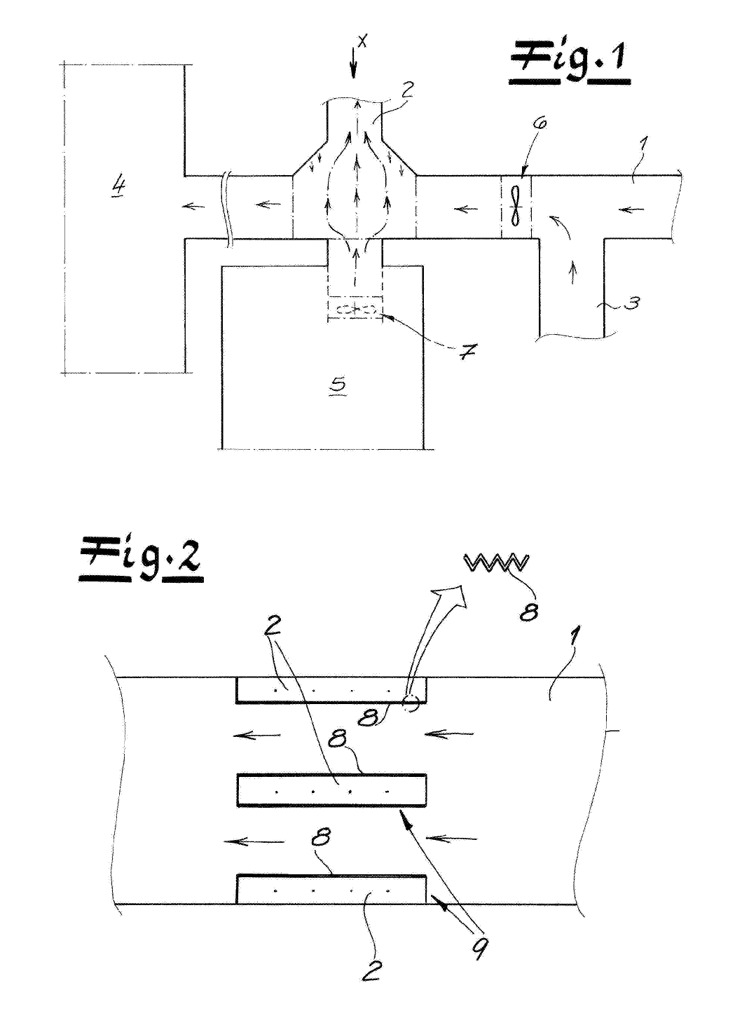

FIG. 1 is an overall view of an inventive apparatus and

FIG. 2 shows a heat exchanger including the inventive membrane in a view taken in direction X of FIG. 1.

The figures show an apparatus for simultaneously exchanging heat and moisture between at least two different gas streams 1 and 2. They are a supply-air stream 1 and an exhaust-gas stream 2. In the embodiment according to FIG. 1, the supply-air stream 1 is also mixed with an ambient-air stream 3, however this is not required and is shown only by way of example. Using the supply-air stream 1 and optionally the ambient-air stream 3, a schematically shown living space 4 is at least partially heated.

An additional so-called heater or boiler 5 is provided for heating or providing hot water. In the illustrated embodiment, the heater or boiler 5 is a so-called gas boiler, i.e. powered by natural gas. The combustion of natural gas oxidizes methane so that the exhaust-gas stream 2 leaving the boiler 5 has a high H₂O content.

In the illustrated embodiment as shown in FIG. 2, the exhaust-gas stream 2 and the supply-air stream 1 move perpendicular to one another. At this point a heat exchanger 9 may be used that is only indicated schematically in FIG. 2 and has individual ducts, perpendicular in the section shown, for the exhaust-gas stream 2, between which the supply-air stream 1 is guided in the drawing plane of FIG. 2, in order to transfer heat from the exhaust-gas stream 2 to the supply-air stream 1.

Fans 6 and 7, which are not shown in detail and of which one is a supply air fan 6 and the other an exhaust air fan 7, ensure that the required flow rates of the supply-air stream 1 and the exhaust air stream 2 are maintained. Of course, the two fans 6 and 7 are not required.

Of particular importance is the fact that the two gas streams 1 and 2 interact with one another through at least one textile exchange membrane 8. In the illustrated embodiment, the textile exchange membrane 8 may be or form a part of the wall of the respective duct for the exhaust-gas stream 2. Instead of the boiler 5 in this example, it is understood that other heating systems, cogenerators, wood stoves, wood-gasification stoves, oil burners, gas burners, etc., may also be used. In addition, the described system is, of course, not limited to use in domestic heating, but rather can also be used in an industrial plant.

It can be seen that the textile exchange membrane 8 is part of a complete gas/gas heat exchanger 9. The gas/gas heat exchanger 9 in the example shown ensures that there is heat exchange between the exhaust-gas stream 2 and the supply-air stream 1 as well as moisture exchange between the exhaust-gas stream 2 and the supply-air stream 1. These exchanges take place concurrently, in each case according to the temperature or moisture content.

The textile exchange membrane 8 is constructed according to the invention such that here, a sheet-like support, for example made of a nonwoven fabric, is used. The nonwoven fabric may be produced by spinning and possible one-sided fixation of polyester threads. The nonwoven fabric in question is subsequently coated with a water-binding filler.

To this end, the nonwoven fabric or a corresponding longitudinally extending length of nonwoven fabric is passed through an immersion bath. The immersion bath is a water suspension of a filler. This means that the filler is present as suspended particles in the water and is applied in this way onto the nonwoven fabric by dip coating. The filler itself is substantially composed of one or more filler materials and a binder. For the immersion bath, one may use a composition of approximately 30 wt. % to 50 wt. % water and 30 wt. % to 50 wt. % filler. In addition, a further 10 wt. % to 20 wt. % binder may be added.

The filler, just as the binder and optional further additives, is present as granules or powder, so that the described dip coating is successful. Here, granules with a diameter of no more than 500 μm have proven particularly advantageous, or powder with a fineness of less than 100 μm. In this way, in the described dip process the filler forms a coating on both faces, both on the upper side as well as the bottom side of the textile fabric or nonwoven fleece. Ultimately, the thickness of the coating can thereby be specified and selected. In addition, it is of course possible to coat the relevant sheet-like support or nonwoven fabric more than once. In this way, both the gas transmission rate as well as the moisture transmission rate for such a membrane 8 can be varied and adjusted to circumstances.

Central within the context of the invention is the fact that the membrane 8 in question is impermeable to the gases or exhaust gases possibly present in the exhaust-gas stream 2, such that they cannot enter the supply-air stream 1. In contrast, it is possible for the moisture in the exhaust-gas stream 2 to diffuse through the membrane 8 in question and thus humidify the supply-air stream 1. The use of a plastic binder or adhesive medium, such as acrylate, in the filler, makes it possible to structure the membrane 8 in a three-dimensional manner, as indicated in an enlarged view in FIG. 2. The surface area of the membrane 8 is increased as a whole and the moisture exchange can thus be optimized. In the example, the membrane 8 has a zigzag profile in cross-section. In addition, measurements have shown that the membrane 8 permits pressure differences between the two gas streams 1 and 2 of more than 2000 Pa without pressure equalization. There is thereby no danger that any gases from the exhaust-gas stream 1 are exchanged and moved into the supply-air stream 1. Rather, the membrane 8 in question is permeable only for the described moisture exchange.

The manufacture of the membrane 8 may be done by deep drawing or a similar plastic deformation technique. For this purpose, the coated support may be heated to temperatures of, for example, 140° C. to 240° C. The binder and the support are deformable at these temperatures.

1. A method for simultaneously exchanging heat and moisture between at least two different gas streams having different temperatures and moisture contents, the method comprising the steps of:
interposing between the streams at least one textile exchange membrane having a sheet-like support coated with a water-binding filler such that moisture in one gas stream is transferred depending on moisture content or concentration level to the other gas stream, and heat is transferred depending on temperature differential.

2. The method according to claim 1, wherein the sheet-like support is made of felt and/or nonwoven fabric and/or fabric and/or knit fabric from polyester fibers or polyester threads.

3. The method according to claim 1, wherein the filler is applied to the sheet-like support as a water suspension.

4. The method according to claim 3, wherein the support is coated by being passed through an immersion bath.

5. The method according to claim 4, wherein the support coated with the filler is dried, for example, with hot air.

6. The method according to claim 1, wherein the filler is substantially composed of a hygroscopic filler material and a binder.

7. The method according to claim 6, wherein inorganic minerals such as aluminum silicates, tectosilicates and/or inorganic salts such as lithium chloride and/or organic absorbers such as polyaniline are used for the filler material.

8. The method according to claim 6, wherein adhesive media based on plastics, such as acrylates, are used as the binder.

9. The method according to claim 3, wherein the filler is mixed in granular or powdered form with water to form a the suspension.

10. The method according to claim 1, such as wherein the binder also contains surfactants, or pigments, anti-bacterial.

11. The method according to claim 1, wherein the sheet-like support coated with the filler has a basis weight between 20 g/m² and 400 g/m².

12. The method according to claim 1, wherein the sheet-like support coated with the filler is three-dimensional.

13. The method according to claim 1, wherein on one side, an exhaust-gas stream from a heat source, is used as a gas stream, and on the other side is used a supply-air stream for space heating.

14. An apparatus for simultaneously exchanging heat and moisture between at least two different gas streams that interact with each other through at least one textile exchange membrane, wherein the moisture in one gas stream is transferred depending on moisture content or concentration level to the other gas stream, and the textile exchange membrane has a sheet-like support that is coated with a water-binding filler.

15. The apparatus according to claim 14, wherein the textile exchange membrane is used in a gas/gas heat exchanger.
